(19) United States
(12) Patent Application Publication
(10) Pub. No.: US 2012/0324361 A1
(43) Pub. Date: Dec. 20, 2012

(54) INFORMATION PROCESSING APPARATUS, INFORMATION MANAGEMENT METHOD AND COMPUTER READABLE INFORMATION RECORDING MEDIUM

(75) Inventor: Yoshinori Fujita, Kanagawa (JP)

(73) Assignee: RICOH COMPANY, LTD., Tokyo (JP)

(21) Appl. No.: 13/471,988

(22) Filed: May 15, 2012

(30) Foreign Application Priority Data
Jun. 20, 2011 (JP) 2011135918

(51) Int. Cl. G06F 3/00

(52) U.S. Cl. 715/738

(57) ABSTRACT

An information processing apparatus is connected with electronic apparatuses storing user information concerning users of the electronic apparatuses. The information processing apparatus receives an operation to designate an electronic apparatus, out of the electronic apparatuses, on which a setting is to be carried out concerning the user information, via a screen page displayed based on apparatus information concerning the electronic apparatuses, and receives an operation of manipulating data of the user information via a screen page displayed based on the user information obtained from the electronic apparatuses and managed by the information processing apparatus. The information processing apparatus transmits to the designated electronic apparatus the user information on which the manipulating data has been carried out, out of the user information managed by the information processing apparatus, and requests the designated electronic apparatus to carry out a setting concerning the user information.

### BACKGROUND OF THE INVENTION

1. Field of the Invention

The present invention relates to a technology of setting user information in an electronic apparatus.

2. Description of the Related Art

For example, information concerning users (hereinafter, simply referred to as user information) is set in an electronic apparatus that is used in an office environment. User information includes information concerning a usage restriction for an electronic apparatus (hereinafter, simply referred to as “usage restriction information”). A manager may set usage restriction information for an electronic apparatus so as to realize operations of the electronic apparatus considering information security (to secure confidentiality), usage costs (to reduce maintenance costs) and so forth.

For this purpose, the following technology has been proposed concerning a setting of usage restriction information for an electronic apparatus.

For example, Japanese Laid-Open Patent Application No. 2007-122366 (Patent reference No. 1) discusses the following technology. In order that a setting (adding, changing or deleting) can be easily carried out and convenience of a manager can be improved, a management apparatus obtains user information of a user who is allowed to use an electronic apparatus (an apparatus which is to be managed) from the electronic apparatus, generates usage restriction information based on a usage restriction policy selected by a manager, and transmits the generated usage restriction information including the obtained user information to the electronic apparatus (an apparatus for which the setting is to be carried out).

However, in the information management of the related art, a process of setting user information may require time.

In the related art, the management apparatus carries out a setting concerning user information by transmitting, to the electronic apparatus to which a setting is to be carried out, not only user information on which the management apparatus has carried out adding, changing, deleting and/or the like, but also all the user information which has been obtained from the electronic apparatus. Therefore, in a case where a large amount of user information has been obtained from the electronic apparatus, data to be transmitted to the electronic apparatus on which the setting is to be carried out and/or data to be processed by the electronic apparatus on which the setting is to be carried out may become larger, and time may be required. Further, in a case where a setting is to be carried out on many electronic apparatuses, time may be further required.

Essentially, it is preferable that the management apparatus only transmits user information on which adding, changing or deleting has been carried out to the electronic apparatus on which a setting is to be carried out and it is preferable that the electronic apparatus on which a setting is to be carried out handles the minimum data for carrying out the setting.

### SUMMARY OF THE INVENTION

According to one aspect of the present invention, an information processing apparatus is connected via a data transmission path with electronic apparatuses that store user information concerning users who use the electronic apparatuses in a storage area. The information processing apparatus includes a reception part configured to receive an operation request via an operation screen page; and a management part configured to store the user information obtained from the electronic apparatuses in the storage area and manage the user information. The reception part is configured to receive an operation to designate an electronic apparatus, out of the electronic apparatuses, on which a setting is to be carried out concerning the user information, via an operation screen page displayed based on apparatus information obtained from the electronic apparatuses and receive an operation of manipulating data of the user information via an operation screen page displayed based on the user information managed by the management part. The management part is configured to transmit to the designated electronic apparatus the user information on which the manipulating data has been carried out, out of the user information managed by the information processing apparatus, and request the designated electronic apparatus to carry out a setting concerning the user information.

Other objects, features and advantages of the present invention will become more apparent from the following detailed description when read in conjunction with the accompanying drawings.

### BRIEF DESCRIPTION OF THE DRAWINGS

FIG. 1 shows a configuration example of a management system according to an embodiment of the present invention;

FIG. 2 shows a hardware configuration example of an information processing apparatus according to the embodiment of the present invention;

FIG. 3 shows a functional configuration example of information management according to the embodiment of the present invention;

FIG. 4 shows a data example of apparatus information according to the embodiment of the present invention;

FIGS. 5A and 5B show a data example of user information according to the embodiment of the present invention;

FIG. 6 shows a data example of data manipulating information according to the embodiment of the present invention;

FIG. 7 is a flowchart showing a process example of displaying an apparatus list according to the embodiment of the present invention;

FIG. 8 shows an example of the apparatus list screen page displayed according to the embodiment of the present invention;

FIG. 9 is a flowchart showing a process example of displaying a user list according to the embodiment of the present invention;

FIG. 10 shows an example of the user list screen page displayed according to the embodiment of the present invention;

FIG. 11 is a flowchart showing a process example of manipulating data of the user information according to the embodiment of the present invention;

FIG. 12 shows an example of a data change screen page displayed according to the embodiment of the present invention; and

FIG. 13 is a flowchart showing a process example of setting transmission according to the embodiment of the present invention.

### DETAILED DESCRIPTION OF THE EMBODIMENT

Below, a preferable embodiment of the present invention (hereinafter, simply referred to as an “embodiment”) will be described in detail using figures.

The embodiment has been devised in consideration of the above-mentioned problem, and an object of the embodiment is to provide an information processing apparatus, an information management method and a computer readable information recording medium by which it is possible to shorten time required for a setting carried out on an electronic apparatus concerning user information.

### <System Configuration>

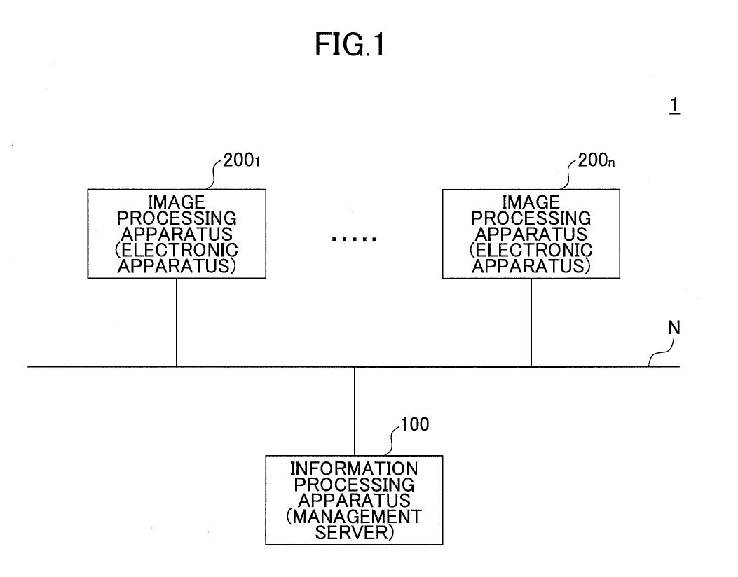

FIG. 1 shows a configuration example of a management system 1 according to the embodiment.

FIG. 1 shows a system configuration example in which plural image processing apparatuses 200₁ through 200ₙ (hereinafter, simply referred to as “image processing apparatuses 200” in a case of generalizing them) and an information processing apparatus 100 are connected via a data transmission path N such as a network (for example, Local Area Network (LAN)).

The image processing apparatuses 200 are apparatuses having image processing functions. The image processing functions may include, for example, a copying function, a printing function, a scanner function and so forth. The image processing apparatuses 200 are examples of electronic apparatuses into which user information is set. Therefore, below, electronic apparatuses will be described assuming that the image processing apparatuses 200 are examples of the electronic apparatuses.

The information processing apparatus 100 is an apparatus having management functions, and acts as a management server. The management functions may include, for example, an apparatus management function of managing the image processing apparatuses 200, an information management function of managing various information items including user information to be transmitted (handled) between the information processing apparatus 100 and the image processing apparatuses 200, and so forth.

The management system 1 provides the following management services in the above-mentioned system configuration. A manager requests the information processing apparatus 100 to display an apparatus list screen page. Using the apparatus management function, the information processing apparatus 100 detects from the system 1 the image processing apparatuses 200 as candidates on which a setting is to be carried out concerning user information, and displays the apparatus list screen page. The manager requests the information processing apparatus 100 to display a user list screen page. The information processing apparatus 100 obtains the user information from the image processing apparatuses 200 using the information management function and displays the user list screen page.

The manager designates from the user list screen page a user for whom the user information will be changed, and requests the change of the user information. The information processing apparatus 100 changes the user information according to the manager's operation to change to user information.

The manager designates from the apparatus list screen page the image processing apparatus 200 on which a setting is to be carried out concerning the user information and requests transmission of the changed user information thereto. The information processing apparatus 100 transmits the changed user information to the designated image processing apparatus 200. Thereby, the image processing apparatus 200 updates the corresponding user information based on the received data.

Thus, in the management system 1 according to the embodiment, it is possible to provide a management service of carrying out a setting concerning user information on the image processing apparatus 200 by the above-mentioned system configuration.

### <Hardware Configuration>

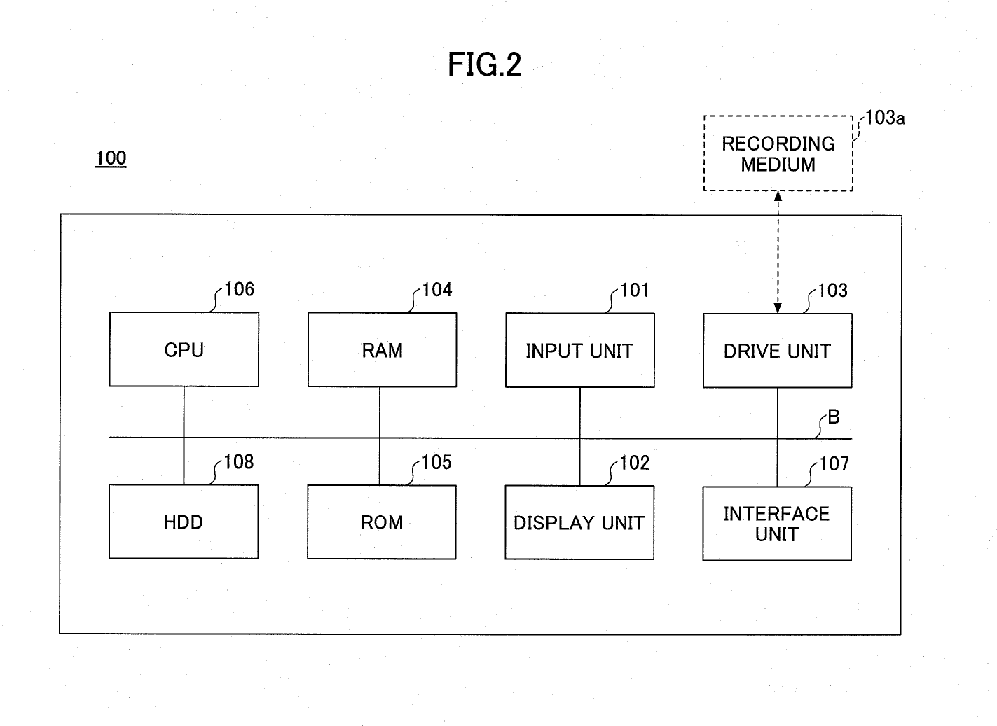

FIG. 2 shows a hardware configuration example of the information processing apparatus 100 according to the embodiment.

As shown in FIG. 2, the information processing apparatus 100 includes an input unit 101, a display unit 102, a drive unit 103, a Random Access Memory (RAM) 104, a Read Only Memory (ROM) 105, a Central Processing Unit (CPU) 106, an interface unit 107 and a Hard Disk Drive (HDD) 108, and the respective parts/units are mutually connected by a bus B.

The input unit 101 includes a keyboard, a mouse and so forth, and is used to input various operation signals to the information processing apparatus 100. The display unit 102 includes a display device, and displays processing results of the information processing apparatus 100.

The interface unit 107 is an interface for connecting the information processing apparatus 100 to the transmission path N. Thereby, the information processing apparatus 100 can carry out data communication with the image processing apparatuses 200 via the interface unit 107.

The HDD 108 is a non-volatile storage device storing programs and data. The programs and data stored therein include an information processing system that controls the whole apparatus (for example, an Operating System (OS) that is basic software such as Windows (trademark or registered trademark), UNIX (trademark or registered trademark) or the like), applications providing various functions (for example, the “information management function”) on the system, and so forth. Further, the HDD 108 manages the programs and data stored using a file system and/or a DataBase (DB).

The drive unit 103 is an interface with a detachable recording medium 103a. Thereby, the information processing apparatus 100 can carry out reading from and/or writing to the recording medium 103a via the drive unit 103. As specific examples of the recording medium 103a, for example, a floppy (trademark or registered trademark) disk, a Compact Disc (CD), a Digital Versatile Disc (DVD), a SD memory card, a Universal Serial Bus (USB) memory and so forth may be cited.

The ROM 105 is a non-volatile semiconductor memory (storage device) which can hold internal data even after power supply thereto is turned off. In the ROM 105, programs and data such as Basic Input/Output System (BIOS) executed at a time of starting up of the information processing apparatus 100, those for information processing system settings and network settings, and so forth, are stored. The RAM 104 is a volatile semiconductor memory (storage device) for temporarily storing the programs and data. The CPU 106 reads the programs and/or data from the above-mentioned storage devices (for example, the HDD 108, the ROM 105, and/or the like) into the RAM 104, performs corresponding processes, carries out control of the whole apparatus, and realizes the functions of the information processing apparatus 100.

Thus, the information processing apparatus 100 according to the embodiment can provide various information processing services including the information management function by the above-mentioned hardware configuration.

### <Information Management Function>

The information management function according to the embodiment will now be described.

The information processing apparatus 100 according to the embodiment obtains apparatus information from the image processing apparatuses 200, and receives an operation of designating the image processing apparatus 200 on which a setting is to be carried out concerning user information, given by the manager based on the obtained apparatus information. Further, the information processing apparatus 100 obtains user information from the image processing apparatuses 200, and receives an operation of manipulating data such as adding data, changing data, deleting data and/or the like, given by the manager based on the obtained user information. As a result, the information processing apparatus 100 transmits to the designated image processing apparatus 200, on which a setting is to be carried out concerning the user information, only the user information (after having undergone the manipulating data) on which the adding data, changing data, deleting data and/or the like has been carried out. The information processing apparatus 100 according to the embodiment has the above-mentioned information management function.

According to the related art, an information processing apparatus carries out a setting concerning user information not only by transmitting the user information on which adding data, changing data, deleting data and/or the like has been carried out, but also by transmitting all the user information obtained from an image processing apparatus (all the user information registered in the image processing apparatus) to an apparatus on which a setting is to be carried out concerning the user information. Therefore, according to the related art, data to be transmitted to the apparatus on which a setting is to be carried out concerning user information and/or data to be processed by the apparatus on which a setting is to be carried out concerning user information is a large amount at a time of the setting concerning user information, and the setting concerning user information into the image processing apparatus carried out by the information processing apparatus may take time.

In order to solve the problem, according to the embodiment, the configuration is provided such that the information processing apparatus 100 transmits, only user information on which adding data, changing data, deleting data and/or the like has been carried out, to the image processing apparatus 200 on which a setting is to be carried out concerning the user information.

Thereby, the information processing apparatus 100 reduces data to be transmitted to the image processing apparatus 200 and data to be processed by the image processing apparatus 200, and provides an environment such that a setting concerning user information in the image processing apparatus 200 can be carried out efficiently. As a result, it is possible to reduce the time required for the information processing apparatus 100 to carry out a setting concerning user information in the image processing apparatus 200, according to the embodiment.

Below, a configuration and operations of the information management function according to the embodiment will be described.

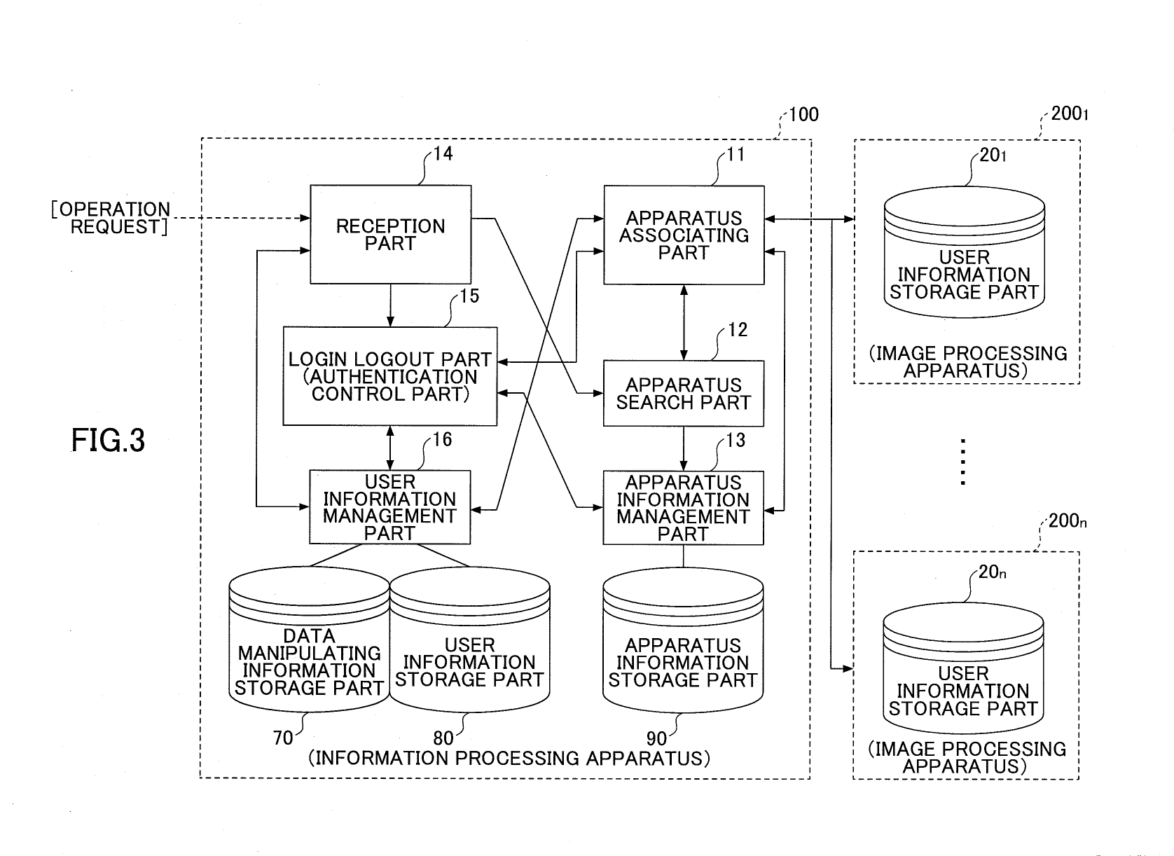

FIG. 3 shows a functional configuration example of information management according to the embodiment.

As shown in FIG. 3, the information management function according to the embodiment includes an apparatus associating part 11, an apparatus search part 12, an apparatus information management part 13, a reception part 14, a login logout part 15 and a user information management part 16. These functional parts operate in the information processing apparatus 100, associate with the image processing apparatus 200 and thus, realize the information management function.

The apparatus associating part 11 is a functional part that controls associating operations with the image processing apparatuses 200. The apparatus associating part 11 responds to receiving an associating operation request for an external apparatus from another functional part by controlling associating operations using data communication between the image processing apparatus 200 and the information processing apparatus 100 (actually, the request-source functional part).

The apparatus search part 12 is a functional part that searches for the image processing apparatuses 200 included in the system 1. The apparatus search part 12 searches for the image processing apparatuses 200 by carrying out broadcasting to the image processing apparatuses 200 connected to the system 1 and confirming the existences of the image processing apparatuses 200 connected to the system 1.

The apparatus information management part 13 is a functional part that manages apparatus information. The apparatus information management part 13 stores the apparatus information of the image processing apparatuses 200 in an apparatus information storage part 90, carries out manipulating data of the apparatus information, and thus carries out information management. It is noted that the apparatus information storage part 90 corresponds to a storage area that the storage device (HDD 108) of the information processing apparatus 100 has.

The apparatus information managed inside the information processing apparatus 100 will now described.

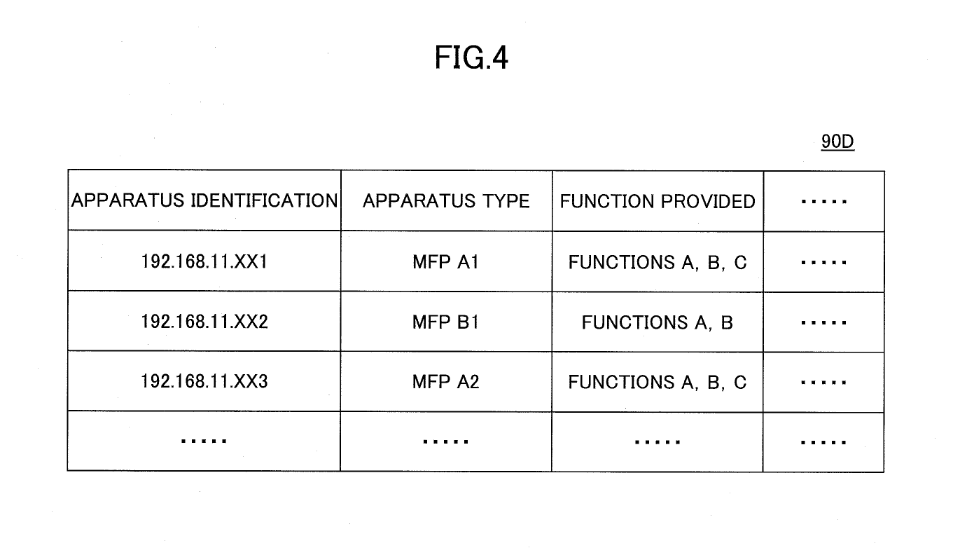

FIG. 4 shows a data example of the apparatus information 90D according to the embodiment.

As shown in FIG. 4, as the apparatus information 90D, information sets are stored and managed separately for the respective image processing apparatuses 200. In each of the information sets, information items such as [apparatus identification], [apparatus type], [functions provided] and so forth are associated with each other.

The item [apparatus identification] is an item for storing information identifying each of the image processing apparatuses 200 (hereinafter, simply referred to as “apparatus identification information”). An item value thereof may be, for example, an apparatus name, a network setting value (Internet Protocol (IP) address) or the like. In the data example of FIG. 4, as one example, network setting values “192.168.11.XX1” through “192.168.11.XX3”, . . . are used as the apparatus identification information.

The item [apparatus type] is an item for storing information indicating an apparatus type of the corresponding image processing apparatus 200 (hereinafter, simply referred to as “apparatus type information”). An item value thereof may be, for example, a code value (apparatus type ID) representing an apparatus type name or an apparatus type. In the data example of FIG. 4, as one example, three apparatus type names “MFP A1”, “MFP B1” and “MFP A2” are used as the apparatus type information.

The item [function provided] is an item for storing information indicating functions provided in the corresponding image processing apparatus 200 (hereinafter, simply referred to as “provided function information”). An item value thereof may be, for example, a code value (application ID) representing an application name or an application. In the data example of FIG. 4, as one example, application names “function A”, “function B” and “function C” are used as the provided function information.

As another example of the information items, an item for storing information indicating an apparatus state of the corresponding image processing apparatus 200 (hereinafter, simply referred to as “apparatus state information”) may be included.

Returning to the description of FIG. 3, when the apparatus search part 12 has confirmed the existences of the image processing apparatuses 200, the apparatus information management part 13 obtains via the apparatus associating part 11 the apparatus information 90D from the image processing apparatus 200 for which the existences thereof have been thus confirmed. The apparatus information management part 13 then accesses the apparatus information storage part 90 and carries out registering data based on the thus obtained apparatus information 90D.

Specifically, the values thus obtained are stored separately for the respective information items. Further, the apparatus information management part 13 displays an apparatus list screen page on the display device of the display unit 102 included in the information processing apparatus 100 based on the apparatus information 90D obtained from the apparatus information storage part 90.

It is noted that “manipulating data” carried out by the apparatus information management part 13 according to an operation request given by the manager may be not only the above-mentioned registering data (adding data) or obtaining data (referring to data) but also changing data (overwriting data), deleting data (erasing data) or the like.

Thus, the information processing apparatus 100 manages the image processing apparatuses 200 in the system 1, and provides to the manager the information concerning the image processing apparatuses 200 as candidates of apparatuses on which a setting is to be carried out concerning user information.

The reception part 14 is a functional part that receives the manager's (operator's) operation request. The reception part 14 receives an operation request via the input unit 101 (for example, a keyboard, a mouse or the like) of the information processing apparatus 100. The reception part 14 then gives instructions to another functional part that performs the requested operation according to the operation request.

It is noted that according to the embodiment, an operation request may be received by the reception part 14 for displaying an apparatus list (searching for external apparatuses), manipulating data (registering, changing or deleting data) of user information, displaying a user list (designating an apparatus from which user information is to be obtained), transmitting user information on which manipulating data has been carried out (designating an apparatus to which a setting is to be carried out concerning the user information), or the like.

Thus, when having received an operation request for displaying an apparatus list (searching for external apparatuses), the reception part 14 gives instructions for the corresponding operation to the apparatus search part 12. Further, when having received an operation request for manipulating data (registering, changing or deleting data) of user information, displaying a user list (designating an apparatus from which user information is to be obtained), or transmitting user information on which manipulating data has been carried out (designating an apparatus on which a setting is to be carried out concerning the user information), the reception part 14 gives instructions for the corresponding operation to the user information management part 16 described later.

It is noted that in a case where an operation request is received for transmitting user information after displaying a user list or manipulating data, instructions for the corresponding operation are also given to the login logout part 15 described later.

The login logout part 15 is a functional part (authentication control part) for controlling login to and logout from the image processing apparatus 200. The login logout part 15 logs in to the image processing apparatus 200 by transmitting authentication information (for example, “login ID”, “password” or the like, hereinafter, referred to as “login information”) that has been input by the manager. Further, after an information management process by another functional part is finished, the login logout part 15 logs out from the image processing apparatus 200 by requesting logout from the image processing apparatus 200 to which login has been carried out. At this time, the login logout part 15 carries out login/logout control (authentication control) for the image processing apparatus 200 by obtaining via the apparatus information management part 13 the apparatus identification information (network setting value) of the corresponding image processing apparatus 200 from the apparatus information 90D and giving the obtained apparatus identification information and the login information to the apparatus associating part 11.

The user information management part 16 is a functional part that manages user information. The user information management part 16 stores user information of the image processing apparatuses 200 in a user information storage part 80, and manages the user information by carrying out manipulating data of the user information in a predetermined manner. It is noted that the user information storage part 80 is a certain storage area in the storage unit 108 (HDD) of the information processing apparatus 100, the same or similar manner as that of the apparatus information storage part 90.

The user information managed inside the information processing apparatus 100 will now be described.

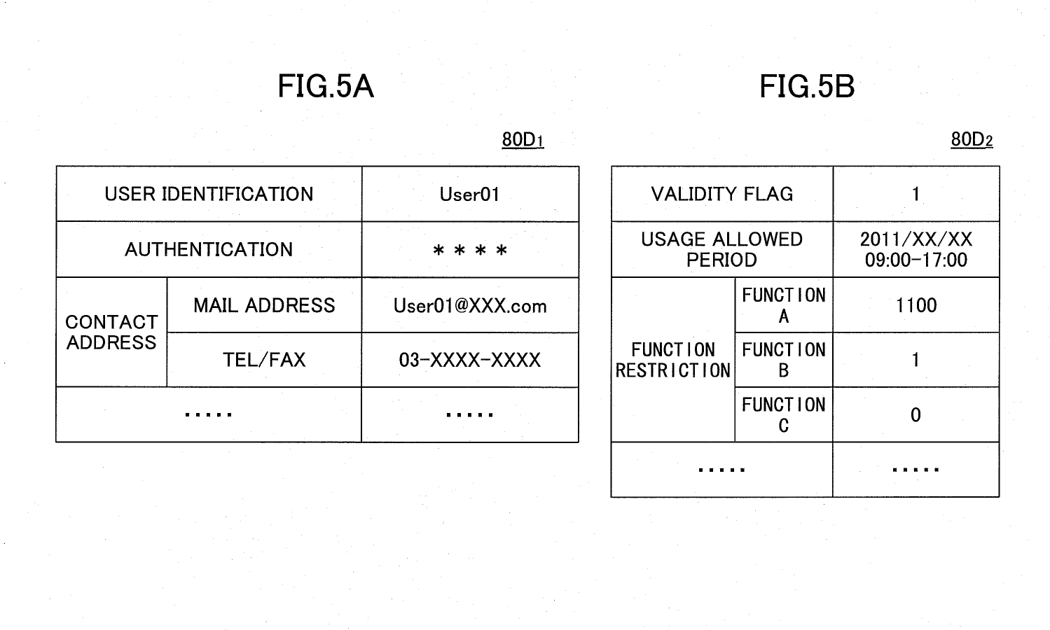

FIGS. 5A and 5B show a data example of the user information 80D according to the embodiment.

As shown in FIGS. 5A and 5B, the user information 80D mainly includes users' registration information 80D₁ (shown in FIG. 5A) and users' usage restriction information 80D₂ (shown in FIG. 5B).

As shown in FIG. 5A, as the registration information 80D₁, information sets are stored and managed separately for respective users. In each of the information sets, items such as [user identification], [authentication] and [contact address] are associated together.

The item [user identification] is an item for storing information identifying a user (hereinafter, referred to as “user identification information”), and as an item value, a code value (ID) indicating a user name or a user may be used.

FIG. 5A shows a data example where a code value “User01” indicating a user is used as the item [user identification].

The item [authentication] is an item for storing users' authentication information, and as an item value, a password may be used, for example. FIG. 5A shows a data example where a password “****” to be input for login to the image processing apparatus 200 is used for the item. It is noted that an item value of the item [authentication] (authentication information) differs depending on an authentication system to be used. For example, in a case where a card authentication system is used, authentication information held by a card may be used. In a case where a biometrics authentication system is used, biological information such as users' fingerprints, retinas or the like may be used.

The item [contact address] is an item for storing information indicating users' contact addresses, and as item values, electronic mail addresses, telephone numbers, facsimile (fax) numbers and/or the like may be used. FIG. 5A shows a data example where all of an electronic mail address “User01@XXX.com” and a telephone and facsimile number “03-XXXX-XXXX” given to the user are stored.

Further, as shown in FIG. 5B, as the usage restriction information 80D₂, information sets are stored and managed separately for the respective users. In each of the information sets, information items such as [validity flag], [usage allowed period] and [function restriction] are associated together.

The item [validity flag] is an item for storing information indicating whether the user is a person who is allowed to use the image processing apparatus 200 (hereinafter, referred to as “valid user information”), and as an item value, a flag value (1 or 0) indicating whether an allowance of usage of the image processing apparatus 200 is valid or invalid may be used, for example. FIG. 5B shows a data example where a flag value “1” indicating a valid user is stored.

It is noted that in a case where the item value is “0”, this means that the user is a person who is not allowed to use the image processing apparatus 200 (hereinafter, referred to as “invalid user information”).

The item [usage allowed period] is an item for storing information indicating a period of time for which usage of the image processing apparatus 200 is allowed (hereinafter, referred to as “usage allowed period information”), and as an item value, for example, dates and times indicating a period of time for which usage of the image processing apparatus 200 is allowed may be used. FIG. 5B shows a data example where dates and times “2011/XX/XX 09:00-11:00” are stored to indicate a period of time from 9:00 through 11:00 at the date 2011/XX/XX.

The item [function restriction] is for storing information indicating a usage restriction for each function, and for example, a bit value or a bit string indicating whether usage of a function is allowed. FIG. 5B shows a data example where a bit value “1” indicating that usage of the function is allowed or a bit value “0” indicating that usage of the function is not allowed are stored for each function (of “function B” and “function C”).

It is noted that in a case where a bit string indicating whether usage of a function is allowed is used, it is possible to indicate whether usage is allowed for each of functions obtained from dividing a function (hereinafter, referred to as “divided functions” for the sake of convenience). For example, in the case of the image processing apparatus 200, a printing function and a copying function are those able to be divided into divided functions. That is, the printing function may be further divided into divided functions, i.e., full color printing, monochrome printing and so forth. The copying function may be further divided into divided functions, i.e., full color copying, monochrome copying, two color copying, single color copying, and so forth. FIG. 5B shows a data example storing a bit string “1100” indicating that usage of the former two of four divided functions of the function A is allowed.

Returning to the description of FIG. 3, when the reception part 14 has received an operation request for displaying a user list, the user information management part 16 obtains via the apparatus associating part 11 user information 80D from the image processing apparatus 200 designated as an apparatus from which user information is to be obtained. The user information management part 16 accesses the user information storage part 80 and carries out registering data therein based on the thus obtained user information 80D.

Specifically, the values thus obtained from the image processing apparatus 200 are stored separately for the respective information items. Further, the user information management part 16 displays a user list screen page on the display unit 102 (display device) of the information processing apparatus 100 based on the user information 80D thus obtained from the image processing apparatus 200.

Thus, the information processing apparatus 100 manages, using the user information management part 16, the users who use the image processing apparatuses 200 in the system 1, and provides the information concerning the users, which is information of candidates on which manipulating data is to be carried out, to the manager.

Further, when the reception part 14 has received an operation request for manipulating data of the user information 80D, the user information management part 16 accesses the user information storage part 80 and carries out registering data for a new user, changing or deleting data for an existing user (who has been already registered in the image processing apparatus 200), or the like.

Specifically, in a case of registering data for a new user, corresponding user information 80D of the new user which has been received when the operation request has been received is stored as a new information set. Further, in a case of changing or deleting data for an existing user, corresponding user information 80D is identified out of the user information stored in the user information storage part 80 based on the user identification information (user ID) of the existing user received when the operation request has been received, and the changing or deleting of data is carried out on the identified user information 80D. In a case of changing data, the value of the corresponding information item of the identified user information 80D is to be overwritten by an input value received when the operation request has been received. In a case of deleting data, the information set of the identified user information 80D is to be deleted.

Further, in a case of having carried out manipulating data of user information 80D, the user information management part 16 records information concerning the manipulating data (hereinafter, referred to as “data manipulating information”) in a data manipulating information storage part 70, and manages the user information 80D (i.e., transmission information to be transmitted for requesting the image processing apparatus 200 to carry out a setting concerning the user information), a setting concerning the user information 80D to be carried out in the image processing apparatus 200 having become necessary because of the manipulating data. It is noted that the data manipulating information storage part 70 corresponds to a certain storage area of the storage unit 108 (HDD) of the information processing apparatus 100, the same as or similar to the apparatus information storage part 90 and the user information storage part 80.

The data manipulating information managed inside the information processing apparatus 100 will now be described.

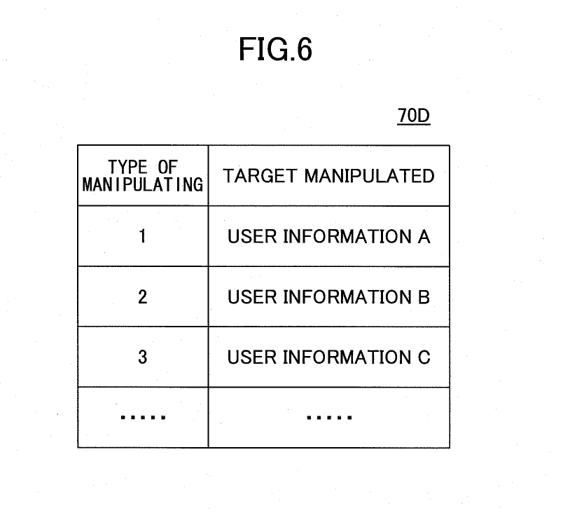

FIG. 6 shows a data example of the data manipulating information 70D according to the embodiment.

As shown in FIG. 6, as the data manipulating information 70D, information sets are stored and managed separately for respective operations of manipulating data. In each of the information sets, information items such as [type of manipulating] and [target manipulated] are associated together.

The item [type of manipulating] is an item for storing information indicating a type of manipulating data carried out to the user information 80D (referred to as “data manipulating type information”), and as an item value, a code value (1, 2 or 3) indicating a type of manipulating data such as registering data, changing data or deleting data may be used. FIG. 6 shows a data example in which a code value “1” indicating registering data, a code value “2” indicating changing data and a code value “3” indicating deleting data are stored.

The item [target manipulated] is an item for storing user information 80D on which manipulating data has been carried out, and as an item value, a copy of the user information 80D (i.e., the copy obtained from the user information storage part 80) may be used. FIG. 6 shows a data example in which respective copies A, B and C of three sets of user information 80D on which registering data, changing data and deleting data has been carried out, respectively, are stored.

Returning to the description of FIG. 3, when manipulating data of user information 80D has been carried out, the user information management part 16 accesses the data manipulating information storage part 70, and registers corresponding new data therein.

Specifically, the code value indicating the type of manipulating and a copy of the user information 80D on which the manipulating data has been carried out are stored in the item [type of manipulating] and the item [target manipulated], respectively.

Further, when the reception part 14 has received an operation request for transmitting user information on which manipulating data has been carried out, the user information management part 16 accesses the data manipulating information storage part 70, and obtains the corresponding data manipulating information 70D. The user information management part 16 transmits the user information 80D on which the manipulating data has been carried out to the image processing apparatus 200 on which a setting is to be carried out concerning the user information, based on the obtained data manipulating information 70D, and requests the image processing apparatus 200 to carry out a setting concerning the user information.

Specifically, transmission data is generated including the data manipulating type information (code value) and the copy of the user information 80D on which the manipulating data has been carried out included in the obtained data manipulating information 70D. That is, the user information management part 16 does not generate transmission data including all the user information 80D obtained from the image processing apparatus 200 but generates transmission data only including the user information 80D on which the manipulating data has been carried out. It is noted that in a case where the data manipulating information 70D includes plural information sets (which include plural sets of data manipulating type information, respectively) corresponding to respective operations of manipulating data, the number of sets of transmission data are generated corresponding to the number of the plural information sets.

The user information management part 16 transmits the generated transmission data to the image processing apparatus 200 on which a setting is to be carried out concerning the user information, by giving to the apparatus associating part 11 the generated transmission data and the apparatus identification information (network setting value) of the image processing apparatus 200 on which a setting is to be carried out concerning the user information (i.e., the image processing apparatus 200 designated as the apparatus on which a setting is to be carried out concerning the user information).

Thus, the information processing apparatus 100 manages by the user information management part 16 user information 80D, a setting concerning it in the image processing apparatus 200 having become necessary as a result of manipulating data having been carried out, and only transmits the user information 80D on which the manipulating data has been carried out to the image processing apparatus 200 that is the apparatus on which a setting is to be carried out concerning the user information. As a result, the image processing apparatus 200 accesses the own user information storage part 20, carries out a setting based on the received user information 80D, and thus, reflects the manipulating data carried out in the information processing apparatus 100 in the user information 80D which the image processing apparatus 200 has.

Thus, the information management function according to the embodiment is realized as a result of the above-mentioned respective functional parts operating in an associating manner. It is noted that the above-mentioned respective functional parts are realized as a result of a program (software realizing the information management function) installed in the information processing apparatus 100 being read from the storage device (HDD 108 or ROM 105) into the memory (RAM 104) by the arithmetic and logic operation unit (CPU 106), and the following processes being performed by the CPU 106.

Detailed operations (the operations of the group of the functional parts in an associating manner) of the information management function according to the embodiment will now be described using flowcharts that indicate processes. It is noted that below, the information management processes according to the above-mentioned operation requests given by the manager will be described in sequence.

### <<Process of Displaying Apparatus List>>

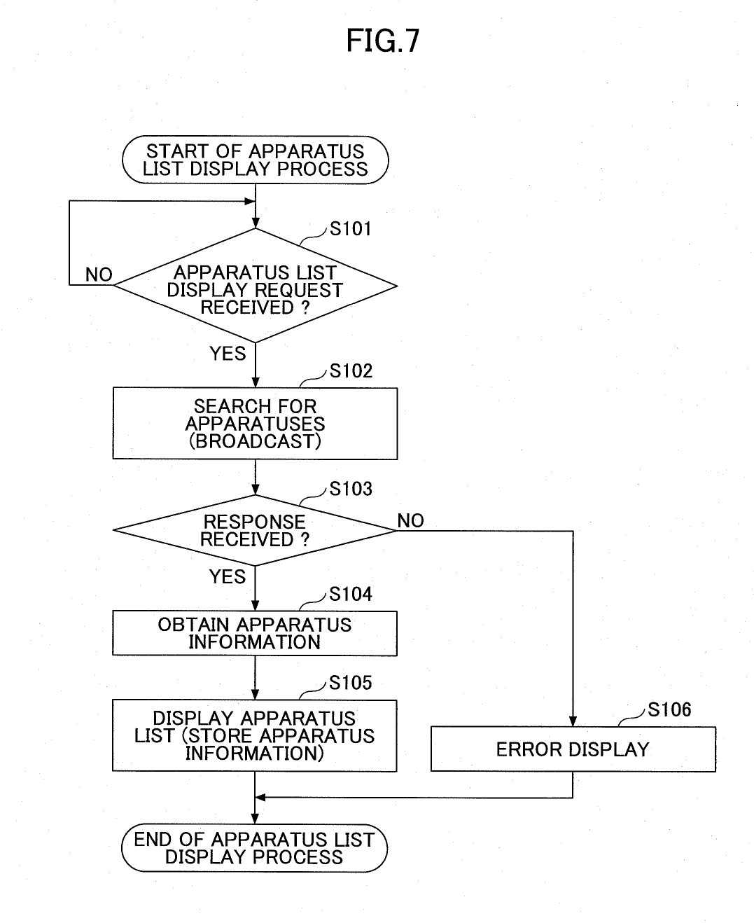

FIG. 7 is a flowchart showing a process example of displaying an apparatus list according to the embodiment.

The information processing apparatus 100 carries out the following process as a result of the reception part 14, the apparatus associating part 11, the apparatus search part 12 and the apparatus information management part 13 operating in an associating manner.

As shown in FIG. 7, the reception part 14 receives an operation request for displaying an apparatus list (step S101 YES). The reception part 14 responds to the received operation request by giving instructions for performing the corresponding process to the functional part (the apparatus search part 12) that executes the operation request.

The apparatus search part 12 searches for the image processing apparatuses 200 included in the system 1 via the apparatus associating part 11 (step S102). At this time, the apparatus search part 12 searches for the image processing apparatuses 200 by carrying out broadcasting to the image processing apparatuses 200 connected to the system 1.

The apparatus search part 12 determines whether there has been received response data from the image processing apparatuses 200 as search results (step S103). It is noted that at this time, the apparatus search part 12 receives the network setting values from the image processing apparatuses 200 as the search results.

In a case of having received response data from the image processing apparatuses 200 (step S103 YES), the apparatus search part 12 gives instructions for displaying an apparatus list screen page to the apparatus information management part 13. A this time, the network setting values of the image processing apparatuses 200 received as the response data are given to the apparatus information management part 13 by the apparatus search part 12.

The apparatus information management part 13 accesses the image processing apparatuses 200 via the apparatus associating part 11 based on the given network setting values, and obtains apparatus information 90D from the image processing apparatuses 200 (step S104).

Based on the obtained apparatus information 90D, the apparatus information management part 13 displays an apparatus list screen page (step S105). At this time, the apparatus information management part 13 accesses the apparatus information storage part 90, stores the values of the obtained apparatus information 90D as the item values of the corresponding information items, and stores them separately for the respective image processing apparatuses 200.

It is noted that in a case of having received no response data from the image processing apparatuses 200 (step S103 NO), the apparatus search part 12 carries out a certain error process (step S106). The error process may be, for example, reporting that no image processing apparatuses 200 exist in the system 1 to be displayed in an apparatus list screen page. Further, a specific method of the reporting may be, for example, not only displaying a corresponding screen page on the information processing apparatus 100 but also outputting a corresponding sound or transmitting a corresponding message.

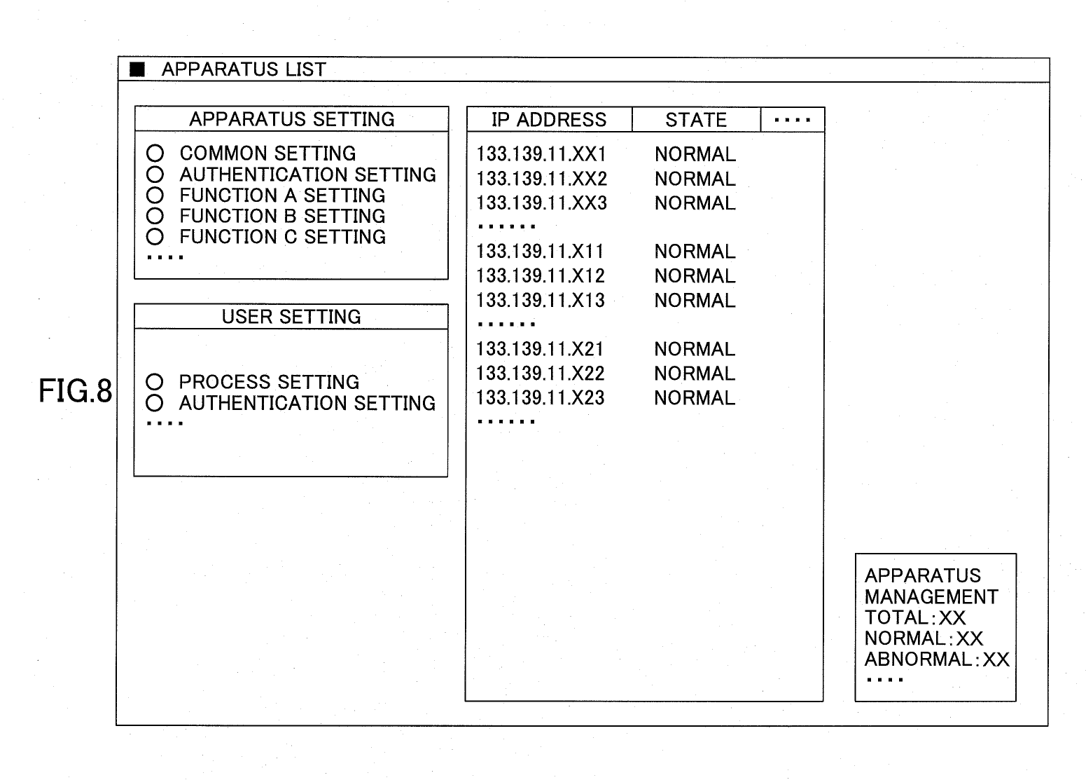

FIG. 8 shows an example of the apparatus list screen page displayed according to the embodiment.

FIG. 8 shows one example of the apparatus list screen page displayed on the information processing apparatus 100 through the above-mentioned process.

In the apparatus list screen page, information concerning the image processing apparatuses 200 for which existence has been confirmed through the process of searching for the image processing apparatuses 200 is displayed in a form of a list. The information concerning the image processing apparatuses 200 thus displayed at this time includes the apparatus identification information (in FIG. 8, the item [IP address]), the apparatus state information (in FIG. 8, the item [state]), and so forth, as shown in FIG. 8.

The manager checks the information thus displayed, and selects one or plural of the image processing apparatuses 200. Thus, the manager designates one or plural of the image processing apparatuses 200 out of those included in the system 1 from which user information 80D is to be obtained for displaying a user list.

### [Process of Displaying User List]

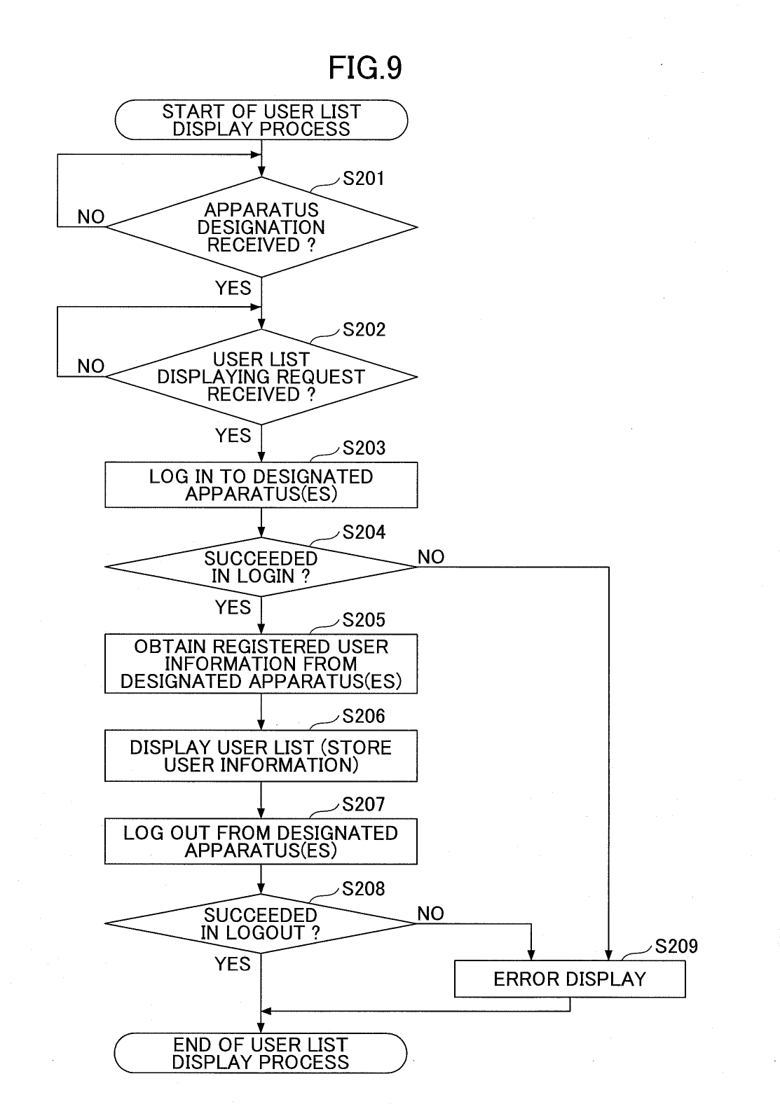

FIG. 9 is a flowchart showing a process example of displaying a user list according to the embodiment.

The information processing apparatus 100 carries out the following process as a result of the reception part 14, the apparatus associating part 11, the apparatus information management part 13, the login logout part 15 and the user information management part 16 operating in an associating manner.

As shown in FIG. 9, the reception part 14 receives via the apparatus list screen page a designation of the image processing apparatus(es) 200 from which user information 80D is to be obtained (step S201 YES), and receives an operation request for displaying a user list (step S202 YES).

The reception part 14 responds to the received operation request by giving instructions for performing the corresponding process to the functional part (the login logout part 15) that executes the operation request.

The login logout part 15 logs in via the apparatus associating part 11 to the image processing apparatus(es) 200 designated as the apparatus(es) from which user information 80D is to be obtained (step S203). At this time, the login logout part 15 obtains from the apparatus information 90D via the apparatus information management part 13 the apparatus identification information (network setting value(s)) of the apparatus(es) from which user information 80D is to be obtained. The login logout part 15 logs in to the image processing apparatus 200 by accessing the image processing apparatus via the apparatus associating part 11 based on the obtained apparatus identification information and transmitting login information that is input by the manager.

The login logout part 15 determines whether the login to the image processing apparatus(es) 200 has succeeded (step S204). It is noted that at this time, the login logout part 15 receives a login result (authentication result) indicating success or failure from the image processing apparatus(es) 200 via the apparatus associating part 11.

In a case of having succeeded in the login to the image processing apparatus(es) 200 (step S204 YES), the login logout part 15 gives instructions for displaying a user list screen page to the user information management part 16. At this time, the network setting value(s) (the apparatus identification information used for the login) of the image processing apparatus(es) 200 for which the login has been succeeded in is (are) given to the user information management part 16 by the login logout part 15.

The user information management part 16 accesses via the apparatus associating part 11 the image processing apparatus(es) based on the network setting value(s), and obtains user information 80D therefrom (step S205).

The user information management part 16 displays a user list screen page based on the obtained user information 80D (step S206). At this time, the user information management part 16 accesses the user information storage part 80, stores the values of the obtained user information 80D as the item values of the respective information items of the registration information 80D₁ and the usage restriction information 80D₂, and stores them separately for the respective users.

After the process of the user information management part 16 has been finished, the login logout part 15 logs out via the apparatus associating part 11 from the image processing apparatus(es) 200 for which the login has been carried out (step S207). At this time, the login logout part 15 logs out from the image processing apparatus(es) 200 by accessing the image processing apparatus(es) 200 via the apparatus associating part 11 and requests it (them) to logout.

The login logout part 15 determines whether there has been success in the logout from the image processing apparatus(es) 200 (step S208).

It is noted that in a case where the login logout part 15 has not succeeded in the login or logout (step S204 NO or step S208 NO), the login logout part 15 carries out a predetermined error process (step S209). The error process may be, for example, reporting having failed in login or logout. A specific method of the reporting may be, for example, not only displaying by a screen page on the information processing apparatus 100 but also outputting a sound or transmitting a message.

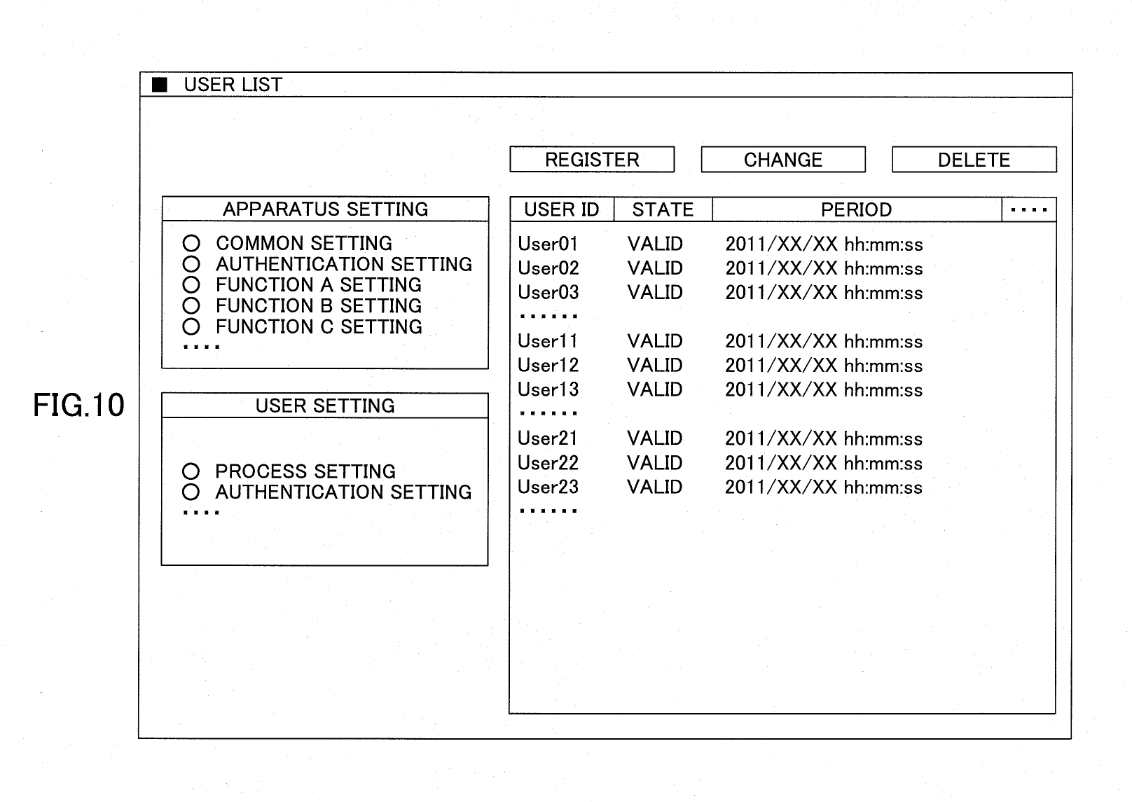

FIG. 10 shows an example of displaying a user list screen page according to the embodiment.

FIG. 10 shows one example of a user list screen page displayed through the above-mentioned process in the information processing apparatus 100.

On the user list screen page, information concerning the existing users of the designated image processing apparatus(es) 200 is displayed in a form of a list. The information concerning the existing users includes the user identification information (in FIG. 10, the item [user ID]), the valid user information (in FIG. 10, the item [state]), the usage allowed period information (in FIG. 10, the item [period]), and so forth.

The manager confirms the displayed information, and carries out manipulating data such as registering, changing or deleting data of user information 80D. For example, in a case of registering data, the manager presses the [register] button on the screen page of FIG. 10, and thereby, a data manipulating screen page (not shown) is displayed. Then, on the displayed data manipulating screen page, the manager sets values (registration values) of information items of user information 80D of a new user and gives instructions for registering them. In a case of changing data, the manager selects a user on the screen page of FIG. 10 for whom changing data is to be carried out and presses the [change] button. As a result, a data manipulating screen page is displayed. Then, on the displayed data manipulating screen page (not shown), the manager sets a new value (changed value) of a corresponding information item of the user information 80D of the selected user and gives instructions for the data change (data replacement). In a case of deleting data, the manager selects on the screen page of FIG. 10 a user to be deleted, presses the [delete] button, and thus, gives instructions for deleting the user information 80D of the selected user.

### <<Process of Manipulating Data>>

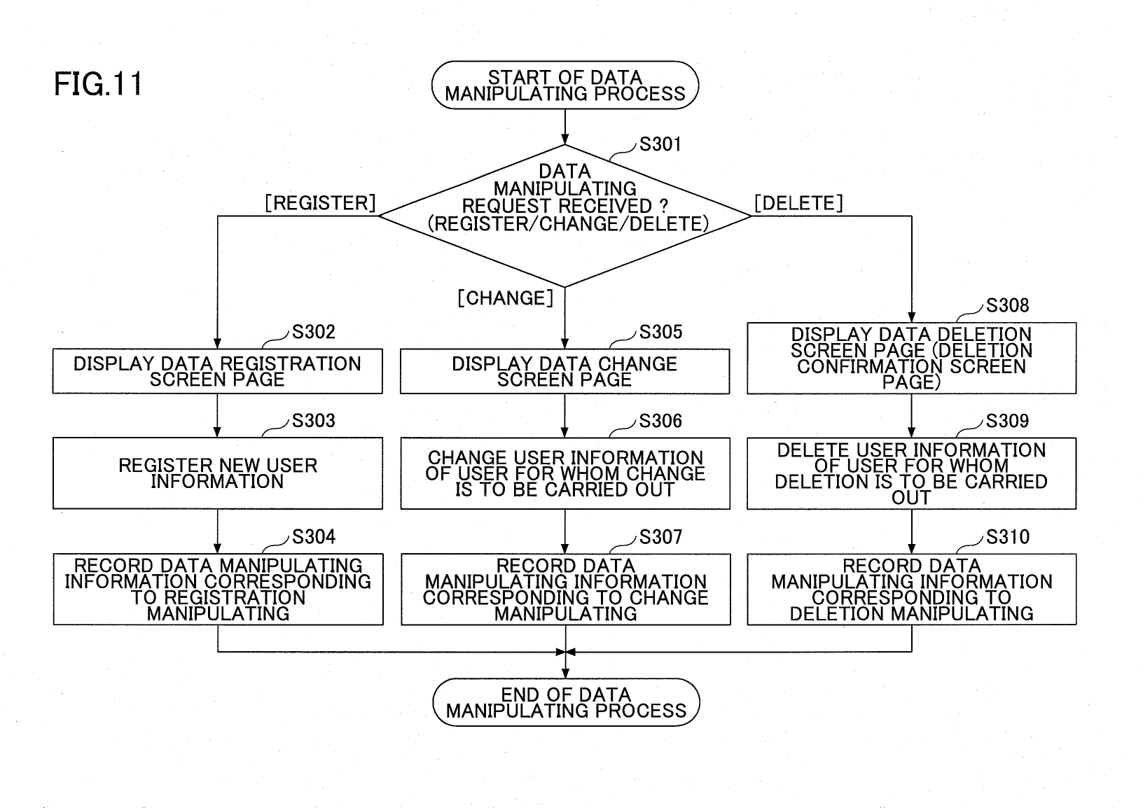

FIG. 11 is a flowchart showing a process example of manipulating data of user information 80D according to the embodiment.

The information processing apparatus 100 carries out the following process as a result of the reception part 14 and the user information management part 16 operating in an associating manner.

As shown in FIG. 11, the reception part 14 receives an operation request for manipulating data of user information 80D via a user list screen page (step S301).

In a case of having received an operation request for registering data (one type of manipulating data) (step S301 [register]), the reception part 14 responds to the received operation request by giving instructions for execution of the process to the functional part (the user information management part 16) that performs registering data.

The user information management part 16 displays a data registration screen page (not shown) (step S302), and registers user information 80D of a new user based on input values (step S303). At this time, the user information management part 16 accesses the user information storage part 80 and stores therein the input values, given by the manager on the displayed data registration screen page, as respective information item values of user information 80D of the new user. Thereby, in the information processing apparatus 100, the new information set corresponding to the user information 80D of the new user is registered.

The user information management part 16 records data manipulating information 70D corresponding to the registering data (step S304). At this time, the user information management part 16 accesses the data manipulating information storage part 70 and stores therein the code value “1” indicating registering data as the type of manipulating data and a copy of the user information 80D having been thus registered, in the item [type of manipulating] and the item [target manipulated], respectively. Thereby, the user information 80D, a setting (registration) thereof in the image processing apparatus 200 having become necessary because of the registering data, is managed in the information processing apparatus 100.

In a case of having received an operation request for changing data (one type of manipulating data) (step S301 [change]), the reception part 14 responds to the received operation request by giving instructions for execution of the process to the functional part (the user information management part 16) that performs changing data.

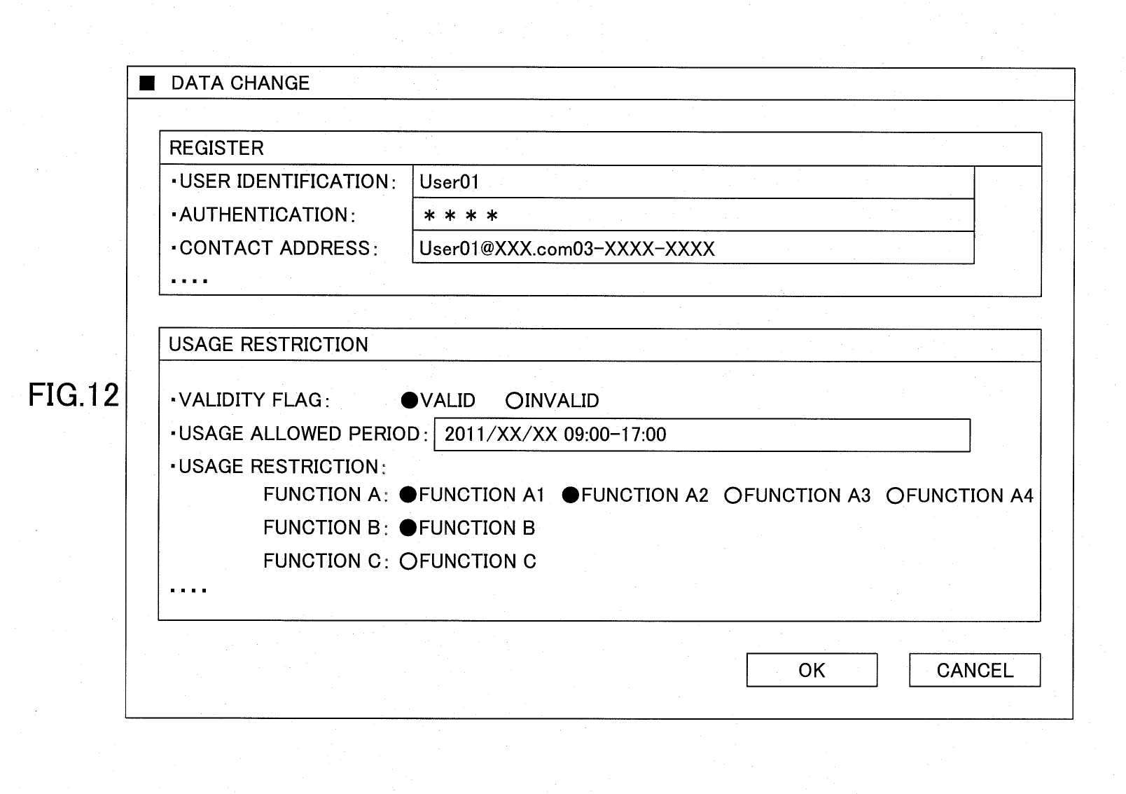

The user information management part 16 displays a data change screen page (described later using FIG. 12) (step S305). It is noted that on the data change screen page displayed at this time, user information 80D is displayed as information item values before being changed. The displayed user information 80D is that of a user for whom the changing data is to be carried out and has been identified out of the user information 80D stored in the user information storage part 80 based on the user identification information (user ID) of the user (designated user) who has been selected on a user list screen page.

Based on input values given by the manager on the displayed data change screen page, the user information management part 16 changes the user information 80D of the designated user for whom the changing data is to be carried out (step S306). At this time, the user information management part 16 accesses the user information storage part 80 and overwrites the values of the corresponding information items of the designated user for whom the changing data is to be carried out by the input values. Thus, in the information processing apparatus 100, the user information 80D of the designated user, out of the existing users, is changed.

The user information management part 16 records the data manipulating information 70D corresponding to the changing data (step S307). At this time, the user information management part 16 accesses the data manipulating information storage part 70 and stores therein the code value “2” indicating changing data as the type of manipulating data and a copy of the user information 80D having been thus changed, in the item [type of manipulating] and the item [target manipulated], respectively. Thereby, the user information 80D, setting (change) thereof in the image processing apparatus 200 having become necessary because of the changing data, is managed in the information processing apparatus 100.

In a case of having received an operation request for deleting data (one type of manipulating data) (step S301 [delete]), the reception part 14 responds to the received operation request by giving instructions for execution of the process to the functional part (the user information management part 16) that performs deleting data.

The user information management part 16 displays a data deletion screen page (or deletion confirmation screen page, not shown) (step S308). It is noted that on the data deletion screen page displayed at this time, user information 80D is displayed. The user information 80D displayed is that of a user (designated user) who is selected by the manager on a user list screen page as the user for whom the deleting data is to be carried out. The user information 80D displayed is identified out of the user information 80D stored in the user information storage part 80 based on the user identification information (user ID) of the designated user.

When having received via the data deletion screen page an operation request given by the manager after confirmation, the user information management part 16 deletes the user information 80D of the designated user for whom the deleting data is to be carried out (step S309). At this time, the user information management part 16 accesses the user information storage part 80 and deletes the information set of the user information 80D of the designated user for whom the deleting data is to be carried out. Thereby, in the information processing apparatus 100, the user information 80D of the designated user is deleted.

The user information management part 16 records data manipulating information 70D corresponding to the deleting data (step S310). At this time, the user information management part 16 accesses the data manipulating information storage part 70 and stores therein the code value “3” indicating deleting data as the type of manipulating data and a copy of the user information 80D before thus being deleted, in the item [type of manipulating] and the item [target manipulated], respectively. Thereby, the user information 80D, setting (deletion) thereof in the image processing apparatus 200 having become necessary because of the deleting data, is managed in the information processing apparatus 100.

FIG. 12 shows an example of a data change screen page displayed according to the embodiment.

FIG. 12 shows one example of a data change screen page displayed through the above-mentioned process on the information processing apparatus 100.

On the data change screen page, the user information 80D of a user for whom changing data is to be carried out is displayed as information before being changed. The user information 80D displayed at this time includes registration information 80D₁ (in FIG. 12, the item [registration]), usage restriction information 80D₂ (in FIG. 12, the item [usage restriction]), and so forth.

The manager inputs new values (change values, to be used for the changing data) using a text box or a selection button (i.e., a graphical user interface (GUI) part) and so forth on the screen page and changes data of the user information 80D. When having finished the inputting new values (change values), the manager presses the button [OK] on the screen page, and thus gives instructions for the change (actual data replacement) operations.

### <<Process of Setting Transmission>>

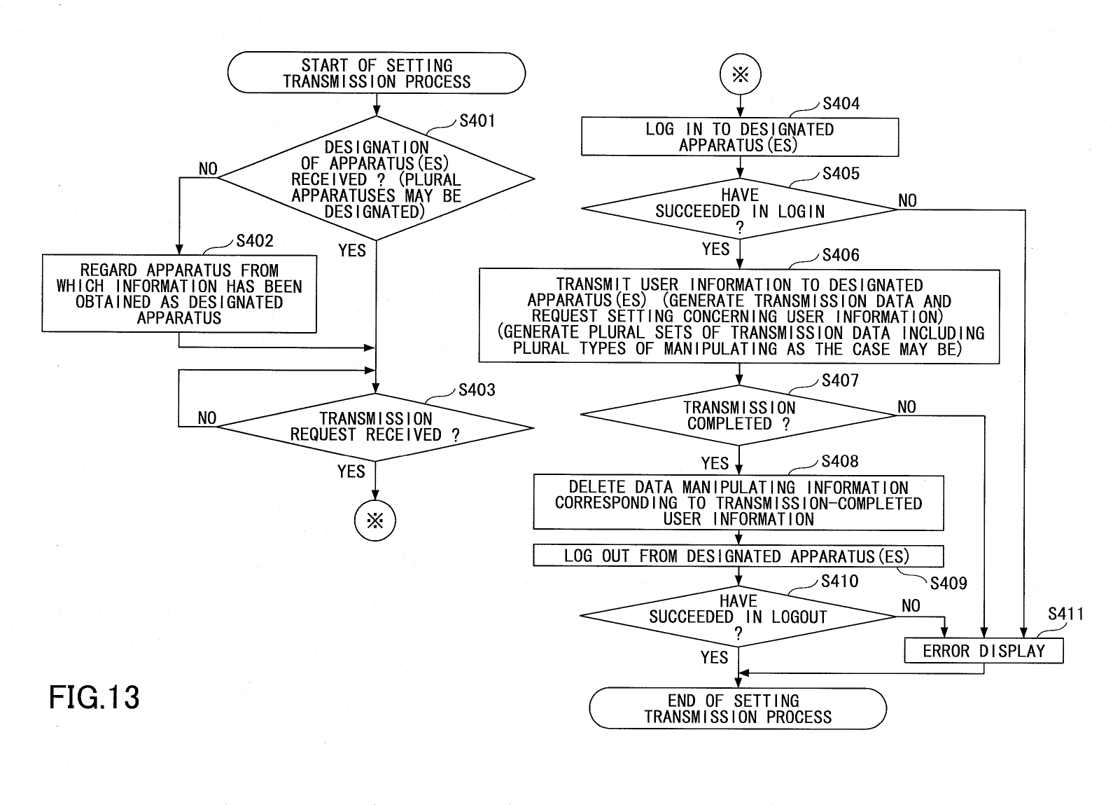

FIG. 13 is a flowchart showing a process procedure example of setting transmission according to the embodiment.

The information processing apparatus 100 carries out the following process as a result of the reception part 14, the apparatus associating part 11, the apparatus information management part 13, the login logout part 15 and the user information management part 16 operating in an associating manner.

As shown in FIG. 13, the reception part 14 receives a designation of an apparatus on which a setting concerning user information 80D on which manipulating data has been carried out is to be carried out via the apparatus list screen page (step S401 YES). At this time, the reception part 14 may receive a designation of not only one apparatus selected but also plural apparatuses on which a setting concerning user information 80D on which manipulating data has been carried out is to be carried out. It is noted that in a case of not having received a designation of an apparatus on which setting of user information 80D on which manipulating data has been carried out is to be carried out (step S401 NO), the apparatus designated when the user information 80D has been obtained (in step S205 of FIG. 9, for example) is regarded as an apparatus on which a setting of the user information 80D on which manipulating data has been carried out is to be carried out (step S402).

When having received a designation of an apparatus on which a setting of user information 80D on which manipulating data has been carried out is to be carried out (step S401 YES) or having determined an apparatus to be regarded as an apparatus on which a setting of user information 80D on which manipulating data has been carried out is to be carried out (step S402), the reception part 14 receives an operation request for transmitting the user information 80D on which manipulating data has been carried out (step S403 YES).

The reception part 14 responds to the received operation request by giving instructions for execution of the process to the functional part (the login logout part 15) that executes the operation request.

The login logout part 15 logs in via the apparatus associating part 11 to one or plural of the image processing apparatuses 200 designated or determined (in step S401 or S402) as the apparatus(as) to which the setting is to be carried out (step S404). At this time, the login logout part 15 obtains from the apparatus information 90D via the apparatus information management part 13 the apparatus identification information (network setting value(s)) of the apparatus(es) on which the setting is to be carried out. The login logout part 15 logs in to the image processing apparatus(es) 200 by accessing via the apparatus associating part 11 the image processing apparatus(es) 200 based on the obtained apparatus identification information and transmitting thereto login information that is input by the manager.

The login logout part 15 determines whether there has been success in the login to the image processing apparatus(es) 200 (step S405). It is noted that at this time, the login logout part 15 receives a login result(s) (authentication result(s)) indicating success or failure from the image processing apparatus(es) 200.

In a case of having succeeded in the login to the image processing apparatus(es) 200 (step S405 YES), the login logout part 15 gives instructions for transmission of the user information 80D on which manipulating data has been carried out to the user information management part 16. The network setting value(s) (the apparatus identification information having been used for the login) of the image processing apparatus(es) 200, for which the login has been succeeded in, is (are) given to the user information management part 16 from the login logout part 15.

Based on the given network setting value(s), the user information management part 16 transmits via the apparatus associating part 11 the user information 80D on which manipulating data has been carried out on the one or plural of the image processing apparatus(es) 200 (step S406). At this time, the user information management part 16 accesses the data manipulating information storage part 70, obtains from the data manipulating information 70D the data manipulating type information (code value) and a copy of the user information 80D on which the manipulating data has been carried out and generates transmission data. Thus, transmission data including all the user information 80D having been obtained from the image processing apparatus(es) 200 (in step S205 of FIG. 9, for example) is not generated but transmission data only including the user information 80D on which the manipulating data has been carried out is generated. At this time, in a case where the data manipulating information 70D includes plural sets of the data manipulating type information (code values), the user information management part 16 generates corresponding plural sets of transmission data based on the plural sets of the data manipulating type information and the corresponding copies of the user information 80D on which the manipulating data has been carried out. The user information management part 16 transmits the generated transmission data to the image processing apparatus(es) 200 based on the network setting value(s) of the image processing apparatus(es) 200, and requests them to carry out the setting concerning the transmitted user information.

The user information management part 16 determines whether the transmission of the user information 80D has been completed (step S407). It is noted that at this time, the user information management part 16 receives a transmission result(s) indicating success or failure from the image processing apparatus(es) 200 via the apparatus associating part 11.

In a case where the transmission of the user information 80D has been completed (step S407 YES), the user information management part 16 deletes the data manipulating information 70D corresponding to the user information 80D, the transmission of which has been completed (step S408). At this time, the user information management part 16 accesses the data manipulating information storage part 70 and deletes the information set of the data manipulating information 70D corresponding to the user information 80D, the transmission of which has been completed.

After the process of the user information management part 16 has been thus finished, the login logout part 15 logs out via the apparatus associating part 11 from the image processing apparatus(es) 200 to which the login has been carried out (step S408). At this time, the login logout part 15 logs out from the image processing apparatus(es) 200 by accessing the image processing apparatus(es) 200 via the apparatus associating part 11 and requests logout from the image processing apparatus(es) 200.

The login logout part 15 determines whether the logout from the image processing apparatus(es) 200 has been succeeded in (step S409).

It is noted that in a case of not having succeeded in login or logout (step S405 NO or step S410 NO), the login logout part 15 carries out a predetermined error process (step S411). The error process may be, for example, reporting having failed in login or logout.

Further, in a case where the transmission of the user information 80D has not been completed (step S407 NO), the user information management part 16 carries out a predetermined error process (step S411). The error process may be, for example, reporting having failed in data transmission.

The specific method of reporting in step S411 may be not only displaying a screen page but also outputting a sound or transmitting a message.

Thus, the information processing apparatus 100 only transmits the user information 80D on which adding, changing or deleting data has been carried out to one or plural of the image processing apparatuses 200 that is (are) an apparatus(es) to which a setting is to be carried out concerning the user information 80D.

It is noted that below, a process of a setting will be described to be carried out in the image processing apparatus 200 based on the user information 80D received from the information processing apparatus 100 through the above-mentioned process.

When having received the user information 80D from the information processing apparatus 100, the image processing apparatus 200 identifies the type of manipulating data having been carried out on the user information 80D based on the data manipulating type information (code value) received together with the user information 80D. The image processing apparatus 200 accesses the own user information storage part 20 and carries out a process of a setting based on the received user information 80D according to the identified type of manipulating data.

Specifically, in a case where the identified type of manipulating data is [register] (registering data or adding data), the received user information 80D is stored in the user information storage part 20 as the respective information item values of the user information 80D of a new user. In a case where the identified type of manipulating data is [change] (changing data), the corresponding information set (the user information of the user for whom the changing data is to be carried out) is identified out of the user information stored in the user information storage part 20 based on the received user information 80D, and the values of the corresponding information items of the user information 80D of the user for whom the changing data is to be carried out are overwritten by the received user information 80D. In a case where the identified type of manipulating data is [delete] (deleting data), the corresponding information set (the user information of the user for whom deleting data is to be carried out) is identified out of the user information stored by the user information storage part 20 based on the received user information 80D, and the identified information set is deleted.

It is noted that in the image processing apparatus 200, in the above-mentioned process of a setting, the following cases may be assumed. That is, for example, there may be a case where, at a time of registering data, the user information 80D of the same user has been already registered (hereinafter, referred to as a “case 1” for the sake of convenience); a case where, at a time of changing or deleting data, the user information 80D of the user for whom changing or deleting data is to be carried out does not exist (hereinafter, referred to as a “case 2” for the sake of convenience); and so forth.

In the case 1, the image processing apparatus 200 identifies the corresponding information set (the user information of the same user) out of the user information stored by the user information storage part 20 based on the received user information 80D, and the identified information set is overwritten by the received user information 80D.

In a case of changing data in the case 2, when the corresponding information set (the user information of the user for whom changing data is to be carried out) cannot be identified out of the user information stored by the user information storage part 20 based on the received user information 80D, the image processing apparatus 200 stores the received user information 80D as the respective information item values of the user information 80D of a new user.

In a case of deleting data in the case 2, when the corresponding information set (the user information of the user for whom deleting data is to be carried out) cannot be identified out of the user information stored by the user information storage part 20 based on the received user information 80D, the image processing apparatus 200 does not carry out the process of deleting for the reason that no data to be deleted exists.

### Summary of Embodiments

Thus, in the information processing apparatus 100 according to the embodiment, the apparatus information management part 13 obtains apparatus information 90D from the image processing apparatus 200, and the reception part 14 receives an operation of designating an apparatus on which a setting is to be carried out, which operation is given based on the obtained apparatus information 90D. Further, in the information processing apparatus 100, the user information management part 16 obtains user information 80D from the image processing apparatus 200, and the reception part 14 receives an operation of manipulating data such as adding, changing or deleting data, which operation is given based on the obtained user information 80D. As a result, in the information processing apparatus 100, the user information management part 16 transmits to the designated apparatus on which a setting is to be carried out only the user information on which adding, changing or deleting data has been carried out (i.e., the user information on which manipulating data has been carried out).

Therefore, it is possible to reduce time required for a setting concerning user information on the image processing apparatus 200 by the information processing apparatus 100.

Thus, according to the embodiment, it is possible to provide an information processing apparatus, an information management method and a computer readable information recording medium by which it is possible to shorten time required for a setting concerning user information in an electronic apparatus.

The embodiment has been described and according to the embodiment, the “information management function” can be realized as a result of a program(s) obtained from coding the respective processes described above using the drawings in a programming language suitable for a given operation environment (platform) being executed by the CPU 106 of the information processing apparatus 100.

The above-mentioned program(s) can be stored by the computer readable recording medium 103a. Thereby, as a result of the program(s) being stored in the recording medium 103a, the program(s) can be installed in the information processing apparatus 100 via the drive unit 103. Further, since the interface unit 107 is included in the information processing apparatus 100, the program(s) can be downloaded via an electrical communication line and can be installed in the information processing apparatus 100.

Further, according to the above-mentioned embodiment, as described above, the information processing apparatus 100 transmits user information 80D on which changing or deleting data has been carried out to the image processing apparatus 200 and requests the information processing apparatus 200 to carry out a setting concerning user information (change or delete data). However, an embodiment of the present invention is not necessarily limited to such a configuration.

For example, in a case of changing data, user identification information (user ID) of a user for whom changing data has been carried out and information item values after being changed out of user information 80D of the user may be transmitted. That is, in this configuration, only the information by which the user can be identified and only the updated values out of the information items are transmitted out of the user information 80D on which changing data has been carried out.

In a case of deleting data, only user identification information (user ID) of a user for whom deleting data has been carried out may be transmitted. In this configuration, only information by which the user for whom deleting data has been carried out can be identified is transmitted.

Thereby, it is possible to further reduce the amount of data to be transmitted to the image processing apparatus 200 by the information processing apparatus 100 and/or the amount of data to be processed by the image processing apparatus 200.

Further, according to the above-mentioned embodiment, the apparatus on which a setting is to be carried out is the image processing apparatus 200 as one example. However, an embodiment of the present invention is not limited thereto. The apparatus on which a setting is to be carried out may be any other electronic apparatus as long as it includes a communication unit and stores user information 80D.

The present invention is not limited to the specifically disclosed embodiment, and variations and modifications may be made without departing from the scope of the present invention.

For example, the form or the configuration of the embodiment may be combined with another element(s). As to this point, the configuration of the embodiment may be freely varied as long as the spirit of the present invention is maintained, and a configuration of an embodiment may be appropriately determined depending on a particular form to which the present invention is to be applied.

The present application is based on Japanese priority application No. 2011-135918 filed Jun. 20, 2011, the entire contents of which are hereby incorporated herein by reference.

What is claimed is:

1. An information processing apparatus connected via a data transmission path with electronic apparatuses that store user information concerning users who use the electronic apparatuses in storage areas, the information processing apparatus comprising:
a reception part configured to receive an operation request via an operation screen page; and
a management part configured to store the user information obtained from the electronic apparatuses in a storage area and manage the user information, wherein
the reception part is configured to receive an operation to designate one of the electronic apparatuses, on which a setting is to be carried out concerning the user information, via the operation screen page displayed based on apparatus information obtained from the electronic apparatuses and receive an operation of manipulating data of the user information via the operation screen page displayed based on the user information managed by the management part, and
the management part is configured to transmit to the designated electronic apparatus the user information on which the manipulating data has been carried out, out of the user information that is managed by the information processing apparatus, and request the designated electronic apparatus to carry out a setting concerning the user information.

2. The information processing apparatus as claimed in claim 1, further comprising:
a storage part configured to store data manipulating information, wherein
the management part is configured to
record in the storage part the data manipulating information corresponding to the manipulating data carried out on the user information,
generate, based on the data manipulating information obtained from the storage part, transmission data to be used when requesting the designated electronic apparatus to carry out the setting concerning the user information, and
transmit the generated transmission data to the designated electronic apparatus.

3. The information processing apparatus as claimed in claim 2, wherein
the management part is configured to
record, in the storage part, the data manipulating information in which manipulating type information indicating a type of the manipulating data and the user information on which the manipulating data has been carried out are associated together, and
generate, in a case of requesting the designated electronic apparatus to carry out a setting concerning the user information, the transmission data based on the manipulating type information and the user information on which the manipulating data has been carried out obtained from the storage part.

4. The information processing apparatus as claimed in claim 3, wherein
in a case where the data manipulating information obtained from the storage part includes plural sets of the manipulating type information, the management part is configured to generate plural sets of transmission data for respective manipulating types based on the plural sets of the manipulating type information and the user information on which the manipulating data has been carried out obtained from the storage part.

5. The information processing apparatus as claimed in claim 2, wherein
in a case where the reception part has received an operation of designating plural of the electronic apparatuses, the management part is configured to transmit the transmission data to the designated plural electronic apparatuses.

6. The information processing apparatus as claimed in claim 1, further comprising:
an authentication control part configured to control login authentication to the electronic apparatuses, wherein
the authentication control part is configured to request login authentication to the designated electronic apparatus before the management part requests the designated electronic apparatus to carry out a setting concerning the user information, and
the management part is configured to transmit the user information on which the manipulating data has been carried out to the designated electronic apparatus in a case where the authentication control part has succeeded in the login authentication, and request the designated electronic apparatus to carry out a setting concerning the user information.

7. An information management method carried out by an information processing apparatus connected via a data transmission path with electronic apparatuses that store user information concerning users who use the electronic apparatuses in storage areas, the information management method comprising:
receiving an operation request via an operation screen page; and
managing the user information obtained from the electronic apparatuses while storing the user information in a storage area, wherein
the receiving receives an operation to designate one of the electronic apparatuses, on which a setting is to be carried out concerning the user information, via the operation screen page displayed based on apparatus information obtained from the electronic apparatuses and receives an operation of manipulating data of the user information via the operation screen page displayed based on the user information managed by the management part, and
the managing transmits to the designated electronic apparatus the user information on which the manipulating data has been carried out, out of the user information that is managed by the information processing apparatus, and requests the designated electronic apparatus to carry out a setting concerning the user information.

8. The information management method as claimed in claim 7, further comprising:
storing in a storage part data manipulating information, wherein
the managing
records in the storage part the data manipulating information corresponding to the manipulating data carried out on the user information,
generates, based on the data manipulating information obtained from the storage part, transmission data to be used when requesting the designated electronic apparatus to carry out the setting concerning the user information, and
transmits the generated transmission data to the designated electronic apparatus.

9. The information management method as claimed in claim 8, wherein
the managing
records, in the storage part, the data manipulating information in which manipulating type information indicating a type of the manipulating data and the user information on which the manipulating data has been carried out are associated together, and
generates, in a case of requesting the designated electronic apparatus to carry out a setting concerning the user information, the transmission data based on the manipulating type information and the user information on which the manipulating data has been carried out obtained from the storage part.

10. The information management method as claimed in claim 9, wherein
in a case where the data manipulating information obtained from the storage part includes plural sets of the manipulating type information, the managing generates plural sets of transmission data for respective manipulating types based on the plural sets of the manipulating type information and the user information on which the manipulating data has been carried out obtained from the storage part.

11. The information management method as claimed in claim 8, wherein
in a case where the receiving has received an operation of designating plural of the electronic apparatuses, the managing transmits the transmission data to the designated plural electronic apparatuses.

12. The information management method as claimed in claim 7, further comprising:
controlling login authentication to the electronic apparatuses, wherein
the controlling requests login authentication to the designated electronic apparatus before the managing requests the designated electronic apparatus to carry out a setting concerning the user information, and
the managing transmits the user information on which the manipulating data has been carried out to the designated electronic apparatus in a case where the controlling has succeeded in the login authentication, and requests the designated electronic apparatus to carry out a setting concerning the user information.

13. A non-transitory computer readable information recording medium storing an information management program which when executed by one or more processors, performs an information management method in an information processing apparatus connected via a data transmission path with electronic apparatuses that store user information concerning users who use the electronic apparatuses in storage areas, the information management method comprising:
receiving an operation request via an operation screen page; and
managing the user information obtained from the electronic apparatuses while storing the user information in a storage area, wherein
the receiving receives an operation to designate one of the electronic apparatuses, on which a setting is to be carried out concerning the user information, via the operation screen page displayed based on apparatus information obtained from the electronic apparatuses and receives an operation of manipulating data of the user information via the operation screen page displayed based on the user information managed by the management part, and
the managing transmits to the designated electronic apparatus the user information on which the manipulating data has been carried out, out of the user information that is managed by the information processing apparatus, and requests the designated electronic apparatus to carry out a setting concerning the user information.
